(19) United States
(12) Patent Application Publication
(10) Pub. No.: US 2026/0085540 A1
(43) Pub. Date: Mar. 26, 2026

(54) AUTOMATIC POOL CLEANING DEVICE AND CONTROL METHOD THEREOF

(71) Applicant: Shenzhen Aiper Intelligent Co., Ltd., Shenzhen (CN)

(72) Inventor: Lujun LI, Suzhou (CN)

(73) Assignee: Shenzhen Aiper Intelligent Co., Ltd., Shenzhen (CN)

(21) Appl. No.: 19/409,190

(22) Filed: Dec. 4, 2025

(30) Foreign Application Priority Data
Dec. 26, 2024 (CN) 202411932217.6

(51) Int. Cl. E04H 4/16; G05D 1/229; G05D 1/648; G05D 105/10; G05D 107/00

(52) U.S. Cl. CPC E04H 4/1654; G05D 1/229; G05D 1/648; G05D 2105/10; G05D 2107/29

(57) ABSTRACT

The present application provides an automatic pool cleaning device and a control method thereof. The method comprises: controlling the device to move from a first position on a pool bottom to a second position on the bottom surface of the pool and performing positioning there to obtain first positioning information, wherein at least a first part of the movement path from the first position to the second position is along an edge of the pool; controlling the device to move from the second position to a third position on the bottom surface and performing a cleaning operation on the bottom surface; controlling the device to move from the third position to a fourth position on the bottom surface and performing positioning there to obtain second positioning information; and controlling the device to move from the fourth position back to the first position based on the first and second positioning information.

### CROSS-REFERENCE TO RELATED APPLICATION

This application claims priority to Chinese Patent Application No. 202411932217.6, filed on Dec. 26, 2024, which is hereby incorporated by reference in its entirety.

### FIELD

The present application relates to the technical field of automation, and in particular, to an automatic pool cleaning device and control method thereof.

### BACKGROUND

When a pool robot first enters into a swimming pool, it cannot determine its enter-into-water position on a map due to the lack of global positioning data in the Earth coordinate system. After completing a task or receiving a recall instruction, the pool robot only chooses to come ashore at the nearest pool edge or returns to the vicinity of the enter-into-water point to come ashore according to the local positioning data in the relative coordinate system. However, the local positioning data has errors, and the pool robot cannot accurately find the enter-into-water position through the local positioning data, which leads to an unstable ashore position and inconsistency with the position of enter-into-water point, resulting in a poor user experience. Similarly, when the pool robot equipped with a charging dock completes its task or runs out of power, it cannot determine the position of the charging dock on the map due to the lack of positioning data. In most instances, the pool robot relies on some traversal methods to find the position of the charging dock, which is inefficient.

### SUMMARY

Embodiments of the present application provides an automatic pool cleaning device and control method thereof, aiming to control the pool robot to return to the enter-into-water position or charging dock quickly and accurately.

An aspect of the present application provides a method of controlling an automatic pool cleaning device, including: controlling the automatic pool cleaning device to move from a first position on a bottom surface of a pool to a second position on the bottom surface and doing positioning at the second position to obtain first positioning information, wherein at least a first part of movement path from the first position to the second position is a path on which the automatic pool cleaning device moves along an edge of the pool; controlling the automatic pool cleaning device to move from the second position to a third position on the bottom surface and performing a cleaning operation on the bottom surface; controlling the automatic pool cleaning device to move from the third position to a fourth position on the bottom surface and doing positioning at the fourth position to obtain second positioning information, where at least a second part of movement path from the third position to the fourth position is a path on which the automatic pool cleaning device moves along the edge of the pool; and controlling the automatic pool cleaning device to move from the fourth position to the first position based on the first positioning information and the second positioning information.

In an embodiment, before controlling the automatic pool cleaning device to move from the first position to the second position, the method further comprises: obtaining map data of the pool.

In an embodiment, the automatic pool cleaning device comprises a sensor, and the obtaining map data of the pool comprises: moving along the edge of the pool for at least a predetermined distance; obtaining in real time a distance from the automatic pool cleaning device to the edge of the pool by using the sensor; and obtaining outline information of the pool based on the distance.

In an embodiment, the doing positioning at the second position to obtain first positioning information comprises: obtaining outline information of the first part of the path; and matching the outline information of the first part of the path with the map data to determine orientation information of the second position relative to the map data, wherein the first positioning information comprises the orientation information of the second position relative to the map data.

In an embodiment, the doing positioning at the fourth position to obtain second positioning information comprises: obtaining outline information of the second part of the path; and matching the outline information of the second part of the path with the map data to determine orientation information of the fourth position relative to the map data, wherein the second positioning information comprises the orientation information of the fourth position relative to the map data.

In an embodiment, the controlling the automatic pool cleaning device to move from the fourth position to the first position based on the first positioning information and the second positioning information comprises: determining orientation information of the first position relative to the map data; determining orientation information of the fourth position relative to the first position based on the orientation information of the first position relative to the map data and the orientation information of the fourth position relative to the map data; and controlling the automatic pool cleaning device to move from the fourth position to the first position based on the orientation information of the fourth position relative to the first position.

In an embodiment, the determining the orientation information of the first position relative to the map data includes: obtaining path information of the automatic pool cleaning device from the first position to the second position; and determining the orientation information of the first position relative to the map data based on the path information and the orientation information of the second position relative to the map data.

In an embodiment, the automatic pool cleaning device comprises an odometer and an inertial measurement unit (IMU), and the path information comprises a movement distance obtained in real time by the odometer and orientation information corresponding to the movement distance.

In an embodiment, the controlling the automatic pool cleaning device to move from the second position to the third position on the bottom surface comprises: controlling the automatic pool cleaning device to move along a preset cleaning path.

In an embodiment, the map is a map under a relative coordinate system.

In an embodiment, the first position includes an enter-into water position or a charging position of the automatic pool cleaning device.

Another aspect of the present application also provides an automatic pool cleaning device, comprises: a processor, and the processor is configured to: control the automatic pool cleaning device to move from a first position on a bottom surface of a pool to a second position on the bottom surface and do positioning at the second position to obtain first positioning information, wherein at least a first part path of movement path from the first position to the second position is a path on which the automatic pool cleaning device moves along an edge of the pool; control the automatic pool cleaning device to move from the second position to a third position on the bottom surface and perform a cleaning operation on the bottom surface; control the automatic pool cleaning device to move from the third position to a fourth position on the bottom surface and do positioning at the fourth position to obtain second positioning information, wherein at least a second part of movement path from the third position to the fourth position is a path on which the automatic pool cleaning device moves along the edge of the pool; and control the automatic pool cleaning device to move from the fourth position to the first position based on the first positioning information and the second positioning information.

Another aspect of the present application provides a non-volatile computer-readable storage medium for storing computer program instructions, where the computer program instructions, when executed by a processor, implement the method described in the foregoing embodiments or examples.

In the automatic pool cleaning device and the control method thereof of the present application, in the process of the cleaning operation, by doing positioning at a part of the positions in the path, the position of the enter-into-water point or charging dock may be accurately determined based on the positioning information, which solves the technical problem in the prior art that the enter-into-water position or charging dock cannot be accurately found through local positioning data, thereby improving the user experience.

The above-mentioned illustration is only an overview of the technical solution of the present application. In order to more clearly understand the technical means of the present application, it may be implemented according to the content of specification, and in order to make the above and other purposes, features and advantages of the present application more obvious and understandable, the specific implementations of the present application are specially exemplified below.

### BRIEF DESCRIPTION OF THE DRAWINGS

In the accompanying drawings, unless otherwise specified, the same reference numerals throughout multiple accompanying drawings represent the same or similar components or elements. These reference numerals are not necessarily drawn to scale. It should be understood that these reference numerals merely depict some implementations of the present application and should not be construed as limiting the scope of the present application.

FIG. 1 shows a flowchart of a method of controlling an automatic pool cleaning device according to an embodiment of the present application.

FIG. 2 shows a schematic diagram of a movement path of an automatic pool cleaning device according to an embodiment of the present application.

FIG. 3 shows a structural schematic diagram of an automatic pool cleaning device according to an embodiment of the present application.

### DETAILED DESCRIPTION OF EMBODIMENTS

Hereinafter, only some exemplary embodiments are briefly described. As is recognized by persons skilled in the art, various modifications to the embodiments described can be made without departing from the concept or scope of the present application. Therefore, the accompanying drawings and descriptions are considered to be exemplary rather than restrictive.

To facilitate understanding of the technical solutions in the embodiments of the present application, the related technologies of the embodiments of the present application are described below. The related technologies, as optional solutions, can be arbitrarily combined with the technical solutions of the embodiments of the present application, and all of them fall within the protection scope of the embodiments of the present application.

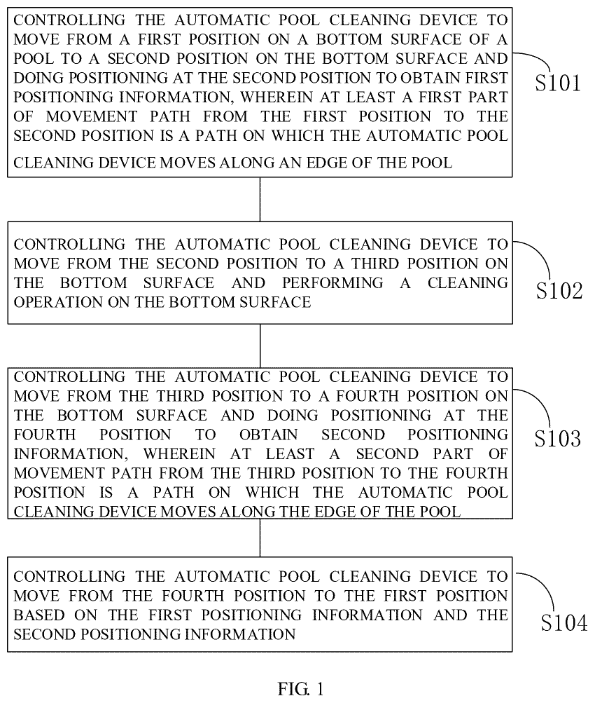

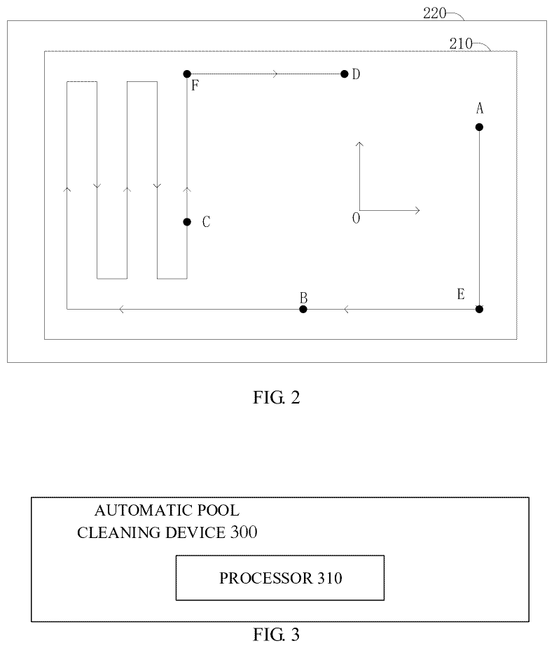

FIG. 1 shows a flowchart of a method of controlling a automatic pool cleaning device according to an embodiment of the present application. FIG. 2 shows a schematic diagram of a movement path of an automatic pool cleaning device according to an embodiment of the present application. The method of controlling the automatic pool cleaning device disclosed in this disclosure will be described with reference to FIGS. 1 and 2.

Referring to FIG. 1, the method of controlling the automatic pool cleaning device includes steps S101 to S104.

In step S101, controlling the automatic pool cleaning device to move from a first position on a bottom surface of a pool to a second position on the bottom surface, and positioning at the second position to obtain first positioning information, wherein at least a first part of the movement path from the first position to the second position is a path on which the automatic pool cleaning device moves along an edge of the pool.

Referring to FIG. 2, point A may be the first position, and point A may be a position on the bottom surface of the pool where the automatic pool cleaning device first reaches after entering the water from the water surface. In the subsequent description, point A is the position of enter-into-water position. Persons skilled in the art may understand that in other examples, the first position may also be a position where the automatic pool cleaning device enters the water from the water surface or from a pool wall, or a position of the charging dock for charging the automatic pool cleaning device. In the present application, as an example for illustration, the first position is considered as a position on the bottom surface of the pool where the automatic pool cleaning device first reaches after entering the water.

Referring to FIG. 2, point B may be the second position. The automatic pool cleaning device may move from point A to point B, and at least a first part of the movement path from point A to point B is a path on which the automatic pool cleaning device moves along an edge of the pool. That is to say, in the path along which the automatic pool cleaning device moves from point A to point B, a part of the path represents that the automatic pool cleaning device moves along an edge of the bottom of the pool wall. For example, in the path from point A to point B, a section of the path near point B represents that the automatic pool cleaning device moves along the edge of the bottom of the pool wall, and the other sections of the path represents that the automatic pool cleaning device moves not along the edge of the bottom of the pool wall. The path from point A to point B may also represents that the automatic pool cleaning device completely moves along the edge of the bottom of the pool wall, e.g., as shown in FIG. 2, moving from point A along the edge of the bottom of the pool wall (along the arrow direction) to point E, and then moving from point E along the edge of the bottom of the pool wall to point B. Thus, the automatic pool cleaning device may perform positioning at point B, that is, the automatic pool cleaning device may determine a position of point B on a map under the relative coordinate system.

Here, the map under the relative coordinate system may be an existing map stored in the memory of the automatic pool cleaning device before the automatic pool cleaning device moves from the first position to the second position, or an outline map of the pool obtained by detecting the pool before the automatic pool cleaning device moves from the first position to the second position. Since there is no underwater base station in the pool, when obtaining the outline map of the pool, the automatic pool cleaning device may not establish a map in the absolute coordinate system. The absolute coordinate system may also be called the Earth coordinate system, and its the coordinate origin is the center of mass of the Earth, that is, the point with longitude 0 and latitude 0 on the Earth. While the automatic pool cleaning device generates a map underwater, its coordinate origin is randomly generated, and thus, the map generated underwater is called the map under the relative coordinate system.

In an embodiment, the automatic pool cleaning device may include a sensor. In order to obtain the map of the pool in the relative coordinate system, the automatic pool cleaning device may move, after entering the water, at least a predetermined distance along the edge of the bottom of the pool wall, and use the sensor to obtain the distance from the automatic pool cleaning device to the edge of the pool in real time; and obtain the contour information of the pool according to the obtained distance. Here, moving at least a predetermined distance along the edge of the bottom of the pool wall may be, for example, moving around the edge of the bottom of the pool wall for one cycle, thereby obtaining the distances for all the collection points at the edge of the bottom of the pool wall. Another example may be moving more than one cycle along the edge of the bottom of the pool wall. Since the starting point and the ending point of the map may not be completely coincident when the map is built, the part exceeding one cycle may be used to correct the position of the starting point and the ending point of the map. Another example may be moving less than one cycle along the edge of the bottom of the pool wall. Distance measuring sensor is generally installed on a side of the automatic pool cleaning device. Since the distance measuring sensor may not only sense the distance of objects directly facing the side of the automatic pool cleaning device, but also sense the distance of objects on the front side or the rear side of the automatic pool cleaning device, as long as the automatic pool cleaning device may obtain the distance data of the edges of the bottom of all the pool walls, it may move along the edge of the bottom of the pool wall for less than one circle, measure the distance of a part of the edge of the bottom of the pool wall. For the remaining part of the edge of the bottom of the pool wall, such as the edge of the bottom of the pool wall on the front side or the rear side of the distance measuring sensor, the distance may also be obtained by this distance measuring sensor. After obtaining the distance to the edge of the bottom of the pool wall, the outline information of the pool may be constructed according to the collected distance information of multiple points on the edge of the bottom of the pool wall, so that a map under the relative coordinate system may be built according to the outline information of the pool.

FIG. 2 shows a schematic diagram of a movement path of an automatic pool cleaning device according to an embodiment of the present application. As shown in FIG. 2, reference mark 220 represents the pool wall of the pool, and reference mark 210 represents the map of the pool obtained by the automatic pool cleaning device in the relative coordinate system. The origin of the map in the relative coordinate system is the position of point O in FIG. 2. It should be noted that the actual edge of the bottom of the pool wall and the outline of the pool in the map under the relative coordinate system may be somewhat irregular and not necessarily an absolute rectangular shape. The outlines of the map 210 and the pool wall 220 in FIG. 2 are merely illustrative.

In an embodiment, in order to achieve the step S101 of positioning at the second position to obtain the first positioning information, the following processes may be taken: first obtaining outline information of the first part of the movement path; and then matching the outline information of the first part of the path with the map data to determine the orientation information of the second position relative to the map data, wherein the first positioning information includes the orientation information of the second position relative to the map data.

Here, since the pool edge information is collected by the robot in the process of moving along the pool edge, the outline information of the path may be the outline information of the pool edge corresponding to the path, for example, including the outline information of the edge of the bottom of the pool wall corresponding to the path. In addition, besides the outline of the edge of the bottom of the pool wall, some information of special markers may also be included, such as the information of obstacles on the pool bottom, pool bottom inlet, pool bottom outlet, pool corner, etc., which have certain characteristics. Here, the orientation information may include position information, that is, coordinate point information in the relative coordinate system, and direction information, such as the orientation of the robot. In addition, since the map obtained by the automatic pool cleaning device is a map under the relative coordinate system, rather than under the absolute coordinate system, when using the map under the relative coordinate system, the automatic pool cleaning device may often do positioning to obtain the positioning information, so that other information may be obtained based on the positioning information. Also, the path may be adjusted according to the positioning information, so as to ensure that the position of the robot does not deviate from the predetermined track. The “positioning” technology in the present application is usually also referred to as “repositioning” in the art.

Referring to FIG. 2, in an embodiment, at least a first part of the movement path from the first position to the second position is the path from point A to point B along the arrow direction, that is, the automatic pool cleaning device moves along the edge of the bottom of the pool wall and turns and then continues to move along the edge of the bottom of the pool wall to point B. To do positioning at point B, the outline information of the path from point A to point B in FIG. 2 (e.g., the outline information of the pool edge from point A to point B along the arrow direction) may be obtained first. Then, the outline information of the path from point A to point B may be matched with the map data obtained previously in the relative coordinate system to determine the coordinates and direction of point B relative to the previously obtained map 210. In an embodiment, when matching the outline information of the first part of the path with the map data, a point cloud registration algorithm may be used. For example, at least a part of the point clouds on the first part of the path may be obtained, and then a part of the point clouds in the map data may be obtained, for example, cloud data for at least three points may be obtained respectively form point cloud pairs, and then each point cloud pair may be matched to determine matching degree. If the matching degree is greater than a preset matching threshold, then it may be determined that the matching is successful. The preset matching threshold, for example, is 80%. When the matching is unsuccessful, more point cloud pairs may be selected for matching until multiple points are matched successfully. In this way, the first part of the path may be determined to correspond to which section of the map. Further, the position of point B on the map and orientation may be determined, thereby obtaining the first positioning information.

In an embodiment, the automatic pool cleaning device may include an odometer. The odometer may include mobile sensor. A distance that the automatic pool cleaning device moves relative to the initial position or relative to the previous position may be estimated using the data obtained from the mobile sensor. The first part of the path may include the movement distances of multiple points obtained in real time by the odometer.

In an embodiment, the automatic pool cleaning device may include a radar sensor, wherein the radar antenna has directionality and may concentrate the emission or reception of electromagnetic waves in a specific direction. By using the radiation pattern of the antenna, the gain of the antenna in different directions may be determined, thereby measuring the direction of the target. Using the combination of the radar sensor and the odometer, the movement distances of multiple displacement points and orientation information corresponding to the movement distances may be obtained in real time. The orientation information may include, for example, the following of the front part of the automatic pool cleaning device: current orientation, tilt angle, etc. The orientation of each displacement point may be used to depict the orientation of the displacement point at the next moment, and after accumulation, the current orientation matrix T_{AB} of the point B relative to point A may be obtained.

In an embodiment, the automatic pool cleaning device may also include an inertial measurement unit (IMU). The IMU may be used to determine the orientation information of the automatic pool cleaning device at each displacement point. Therefore, on the first part of the path, the movement distances of multiple displacement points may be obtained in real time by the odometer and the orientation information corresponding to the movement distances may be obtained by the IMU. The orientation information may include, for example, the following of the front part of the automatic pool cleaning device: current orientation, tilt angle, etc. The orientation of each displacement point may be used to depict the orientation of the displacement point at the next moment, and after accumulation, the current orientation matrix T_{AB} of point B relative to point A may be obtained.

In addition, in an embodiment, the IMU may also be used for real-time calibration of the odometer.

The above contents introduce an example and implementation of the automatic pool cleaning device positioning at the second position to obtain the first positioning information. By doing positioning at the second position, the position on the map under the relative coordinate system constructed by the automatic pool cleaning device corresponding to the second position may be determined. Thus, subsequent positioning and calculations may be further carried out, and the position of the automatic pool cleaning device may be detected in real time, thereby avoiding movement deviations.

In step S102, controlling the automatic pool cleaning device to move from the second position to a third position on the bottom surface and performing a cleaning operation on the bottom surface.

In an embodiment, the automatic pool cleaning device may be controlled to move from the second position to the third position along a preset cleaning path. In FIG. 2, the second position is point B and the third position is point C. Point C in FIG. 2 may represent the position where the automatic pool cleaning device stops its cleaning operation. Usually, the automatic pool cleaning device may stop its cleaning operation if any one of the following conditions is satisfied: it has completed cleaning task, the power is insufficient, or a recall instruction is received. After doing positioning at point B in the previous step, in this step, the automatic pool cleaning device may perform a cleaning operation along the preset cleaning path. The preset cleaning path may be a preset movement path or a preset movement rule. The preset movement path may be, for example, a path with strong underwater positioning ability and small walking deviation, such as an S-shaped or U-shaped path. The preset movement rule may be, for example, a bow-shape movement rule. For example, as shown in FIG. 2, the automatic pool cleaning device starts straight from the lower left corner of the pool, turns 90 degrees after encountering an obstacle, moves straight for a certain distance or duration after the turning, then turns 90 degrees again, and then moves straight, and so on, until the automatic pool cleaning device stops its cleaning operation or is recalled, or needs to charge and return.

In step S103, controlling the automatic pool cleaning device to move from the third position to a fourth position on the bottom surface and doing positioning at the fourth position to obtain second positioning information, wherein at least a second part of the movement path from the third position to the fourth position is a path on which the automatic pool cleaning device moves along the edge of the pool.

Referring to FIG. 2, point D may be the fourth position. The way to do positioning at the fourth position is similar to that of doing positioning at the second position in the above-mentioned step S101. The automatic pool cleaning device may move from point C to point D. At least a second part of the movement path from point C to point D is the path on which the automatic pool cleaning device moves along the edge of the pool. That is to say, the path from point C to point D of the automatic pool cleaning device may be a path that moves completely along the edge of the bottom of the pool wall, or a part of the path may be a path on which the automatic pool cleaning device moves along the edge of the bottom of the pool wall. For example, in the path from point C to point D, a section of the path near point D is a path on which the automatic pool cleaning device moves along the edge of the bottom of the pool wall. Other parts of the path may be paths on which the automatic pool cleaning device does not move along the edge of the bottom of the pool wall. For example, after stopping cleaning operations at point C, the automatic pool cleaning device may move from point C along a preset cleaning path to the nearest edge of the bottom of the pool wall, and then move a predetermined distance along the edge of the bottom of the pool wall to point D. The path on which the automatic pool cleaning device moves the predetermined distance along the edge of the bottom of the pool wall to point D or a part of this path may be the second part path. Thus, the automatic pool cleaning device may do positioning at point D, that is, the automatic pool cleaning device may determine the position in the map under the relative coordinate system for point D.

In an embodiment, in order to achieve the step S103 of doing positioning at the fourth position to obtain the second positioning information, outline information of the second part of the path is obtained first; and then the outline information of the second part of the path is matched with the map data to determine orientation information of the fourth position relative to the map data, wherein the second positioning information includes the orientation information of the fourth position relative to the map data.

Similar to the aforementioned example, since the pool edge information is collected by the automatic pool cleaning device in the process of moving along the pool-edge path, the outline information of the path may be the outline information of the pool edge corresponding to the path, for example, including “outline information of the edge of the bottom of the pool wall” corresponding to the path. In addition, besides the outline of the edge of the bottom of the pool wall, some information of special markers may also be included, such as the information of obstacles on the pool bottom, e.g., bottom inlet, bottom outlet, pool corner, etc., which have certain characteristics. Here, “orientation information” may include position information (i.e., coordinate point information in the relative coordinate system) and direction information. In addition, since the map obtained by the automatic pool cleaning device is a map under the relative coordinate system, not in the absolute coordinate system, when using the map under the relative coordinate system, the automatic pool cleaning device may often doing positioning to ensure that the position does not deviate from the predetermined path. The “positioning” technology in the present application is usually also referred to as “repositioning”.

Referring to FIG. 2, in an embodiment, at least a second part of the movement path from the third position to the fourth position is a path from point F, which is the point on the edge of the bottom of the pool wall closest to point C, to point D along the arrow direction. To doing positioning at point D, the outline information of the path from point F to point D in FIG. 2 may be obtained first, for example, the outline information of the pool edge along the arrow direction from point F to point D. Then the outline information of the second part path is matched with the previously obtained map data in the relative coordinate system to determine the coordinates and direction of point D relative to the map 210. In an embodiment, when matching the outline information of the second part of the path with the map data, a point cloud registration algorithm may be used. For example, at least a part of the point clouds on the second part of the path is obtained, and then a part of the point clouds in the map data is obtained, for example, cloud data for at least three points may be obtained respectively form point cloud pairs, and then each point cloud pair may be matched to determine matching degree. If the matching degree is greater than a preset matching threshold, then it may be determined that the matching is successful. The preset matching threshold, for example, is 80%. When the matching is unsuccessful, more point cloud pairs may be selected for matching until multiple points are matched successfully. In this way, the second part of the path may be determined to correspond to which section of the map. Further, the position of point D on the map and orientation direction may be determined, thereby obtaining the second positioning information.

In an embodiment, the automatic pool cleaning device may include an odometer. The odometer may estimate a distance that the automatic pool cleaning device moves relative to the initial position or relative to the previous position using the data obtained from a mobile sensor. The second part of the path may include the movement distances of multiple displacement points obtained in real time by the odometer.

In an embodiment, the automatic pool cleaning device may include a radar sensor, where the radar antenna has directionality and may concentrate the emission or reception of electromagnetic waves in a specific direction. By using the radiation pattern of the antenna, the gain of the antenna in different directions may be determined, thereby measuring the direction of the target. Using the combination of the radar sensor and the odometer, the movement distances of multiple displacement points and the orientation information corresponding to the movement distances may be obtained in real time. The orientation information may include, for example, the following of the front part of the automatic pool cleaning device: current orientation, tilt angle, etc. The orientation of each displacement point in the second part of the path may be used to depict the orientation of the displacement point at the next moment, and after accumulation, the current orientation matrix T_{FD} of the point F relative to point D may be obtained.

In an embodiment, the automatic pool cleaning device may include an inertial measurement unit (IMU). The IMU may be used to determine the orientation information of the automatic pool cleaning device at each displacement point. Therefore, the second part of the path may include the movement distances of multiple displacement points obtained in real time by the odometer, and the orientation information corresponding to the movement distances obtained by the IMU. The orientation information may include, for example, the following of the front part of the automatic pool cleaning device: current orientation, tilt angle, etc. The orientation of each displacement point may be used to depict the orientation of the displacement point at the next moment, and after accumulation, the current orientation matrix T_{FD} of point F relative to point D may be obtained.

The above contents introduce an example and implementation of the automatic pool cleaning device which does positioning at the fourth position to obtain the second positioning information. By doing positioning at the fourth position, the position on the map under the relative coordinate system constructed by the automatic pool cleaning device for the fourth position may be determined. Thus, subsequent positioning and calculations may be further carried out, and the position of the automatic pool cleaning device may be detected in real time, thereby avoiding movement deviations.

In step S104, controlling the automatic pool cleaning device to move from the fourth position to the first position based on the first positioning information and the second positioning information.

In an embodiment, the controlling the automatic pool cleaning device to move from the fourth position to the first position based on the first positioning information and the second positioning information may first determine orientation information of the first position relative to the map data; determine orientation information of the fourth position relative to the first position based on the orientation information of the first position relative to the map data and the orientation information of the fourth position relative to the map data; and control the automatic pool cleaning device to move from the fourth position to the first position based on the orientation information of the fourth position relative to the first position.

In an embodiment, the determining the orientation information of the first position relative to the map data includes: obtaining path information of the automatic pool cleaning device from the first position to the second position, and determining the orientation information of the first position relative to the map data based on the path information and the orientation information of the second position relative to the map data.

Referring to FIG. 2, point A represents the first position, point B represents the second position, and point D represents the fourth position. According to the description of the previous example, after determining the path from point A to point B, the orientation matrix T_{AB} of point B relative to point A may be obtained. After doing positioning at point B, the orientation matrix T_{OB} of point B relative to the origin O of the relative coordinate system may be obtained. Through the formula T_{OA}=T_{OB}T_{AB}⁻¹, the orientation matrix T_{OA} of point A in the relative coordinate system may be obtained, wherein T_{AB}-1 represents the inverse matrix of T_{AB}.

After determining the orientation matrix T_{OA} of point A in the relative coordinate system, the orientation matrix T_{OD} of point D relative to the origin O of the relative coordinate system may be obtained by doing positioning at the fourth position. Through the formula T_{DA}=T_{OD}⁻¹T_{OA}, the relative orientation T_{DA} between A and D may be obtained, wherein T_{OD}⁻¹ represents the inverse matrix of T_{OD}. Through T_{DA}, the robot may be navigated from point D to the enter-into-water point A at the bottom of the pool or the position A where the charging dock is located, and then the robot comes ashore.

In the embodiments of the present application, by doing positioning at some points in the movement path of the automatic pool cleaning device and calculating the position of the robot's enter-into-water position based on the positioning data, the problem in the prior art, i.e., in the map under the relative coordinate system, positioning is not performed and it is impossible to remember the positions of the enter-into-water point and the charging dock, is solved.

FIG. 3 shows a structural schematic diagram of an automatic pool cleaning device according to an embodiment of the present application. Referring to FIG. 3, the automatic pool cleaning device 300 includes a processor 310, and the processor is configured to: control the automatic pool cleaning device to move from a first position on a bottom surface of a pool to a second position on the bottom surface and do positioning at the second position to obtain first positioning information, wherein at least a first part of movement path from the first position to the second position is a path on which the automatic pool cleaning device moves along an edge of the pool; control the automatic pool cleaning device to move from the second position to a third position on the bottom surface and perform a cleaning operation on the bottom surface; control the automatic pool cleaning device to move from the third position to a fourth position on the bottom surface and do position at the fourth position to obtain second positioning information, wherein at least a second part of movement path from the third position to the fourth position is a path on which the automatic pool cleaning device moves along the edge of the pool; and control the automatic pool cleaning device to move from the fourth position to the first position based on the first positioning information and the second positioning information.

The above-mentioned functions of the processor 310 are similar to the steps in the methods of controlling the automatic pool cleaning device in the previous embodiments. Specific details may be referred to the previous embodiments and examples, and will not be repeated here.

Another aspect of the present application also provides a non-volatile computer-readable storage medium for storing computer program instructions, where the computer program instructions, when executed by a processor, implement the method described in the foregoing embodiments or examples.

In the description of the present specification, the reference terms “an embodiment”, “some embodiments”, “examples”, “specific examples”, or “some examples”, etc., refer to that the specific features, structures, materials, or characteristics described in combination with this embodiment or example are included in at least one embodiment or example of the present application. Further, the specific features, structures, materials or characteristics described may be combined in any one or more of embodiments or examples with a suitable manner. In addition, without contradicting each other, persons skilled in the art may combine and assemble the different embodiments or examples and the features of different embodiments or examples described in the present specification.

Moreover, the terms “first” and “second” are only used to described purposes and are not to be understood as indicating or implying relative importance or as implicitly indicating the quantity of technical features indicated. In view of this, a feature defined as “first” or “second” may explicitly or implicitly include at least one feature. In the description of the present application, “multiple” means two or more, unless otherwise expressly and specifically defined.

The contents described above are only exemplary implementations of the present application, and cannot be used to limit the protection scope of the present application. In technical scope recorded in the present application, persons skilled in the art may easily think of various changes or replacements thereof, which all shall be covered within the protection scope of the present application. Therefore, the protection scope of the present application shall be governed by the protection scope of claims.

1. A method of controlling an automatic pool cleaning device, comprising:
controlling the automatic pool cleaning device to move from a first position on a bottom surface of a pool to a second position on the bottom surface and doing positioning at the second position to obtain first positioning information, wherein at least a first part of movement path from the first position to the second position is a path on which the automatic pool cleaning device moves along an edge of the pool;
controlling the automatic pool cleaning device to move from the second position to a third position on the bottom surface and performing a cleaning operation on the bottom surface;
controlling the automatic pool cleaning device to move from the third position to a fourth position on the bottom surface and doing positioning at the fourth position to obtain second positioning information, wherein at least a second part of movement path from the third position to the fourth position is a path on which the automatic pool cleaning device moves along the edge of the pool; and
controlling the automatic pool cleaning device to move from the fourth position to the first position based on the first positioning information and the second positioning information.

2. The method according to claim 1, wherein before controlling the automatic pool cleaning device to move from the first position to the second position, the method further comprises:
obtaining map data of the pool.

3. The method according to claim 2, wherein the automatic pool cleaning device comprises a sensor, and the obtaining map data of the pool comprises:
moving along the edge of the pool for at least a predetermined distance;
obtaining in real time a distance from the automatic pool cleaning device to the edge of the pool by using the sensor; and
obtaining outline information of the pool based on the distance.

4. The method according to claim 2, wherein the doing positioning at the second position to obtain first positioning information comprises:
obtaining outline information of the first part of the path; and
matching the outline information of the first part of the path with the map data to determine orientation information of the second position relative to the map data, wherein the first positioning information comprises the orientation information of the second position relative to the map data.

5. The method according to claim 4, wherein, the doing positioning at the fourth position to obtain second positioning information comprises:
obtaining outline information of the second part of the path; and
matching the outline information of the second part of the path with the map data to determine orientation information of the fourth position relative to the map data, wherein the second positioning information comprises the orientation information of the fourth position relative to the map data.

6. The method according to claim 5, wherein the controlling the automatic pool cleaning device to move from the fourth position to the first position based on the first positioning information and the second positioning information comprises:
determining orientation information of the first position relative to the map data;
determining orientation information of the fourth position relative to the first position based on the orientation information of the first position relative to the map data and the orientation information of the fourth position relative to the map data; and
controlling the automatic pool cleaning device to move from the fourth position to the first position based on the orientation information of the fourth position relative to the first position.

7. The method according to claim 6, wherein the determining the orientation information of the first position relative to the map data comprises:
obtaining path information of the automatic pool cleaning device from the first position to the second position; and
determining the orientation information of the first position relative to the map data based on the path information and the orientation information of the second position relative to the map data.

8. The method according to claim 7, wherein the automatic pool cleaning device comprises an odometer and an inertial measurement unit (IMU), and the path information comprises a movement distance obtained in real time by the odometer and orientation information corresponding to the movement distance.

9. The method according to claim 1, wherein the controlling the automatic pool cleaning device to move from the second position to the third position on the bottom surface comprises:
controlling the automatic pool cleaning device to move along a preset cleaning path.

10. The method according to claim 2, wherein the map is a map under a relative coordinate system.

11. The method according to claim 1, wherein the first position comprises a enter-into-water position or a charging position of the automatic pool cleaning device.

12. A automatic pool cleaning device, comprising: a processor, and the processor is configured to:
control the automatic pool cleaning device to move from a first position on a bottom surface of a pool to a second position on the bottom surface and do positioning at the second position to obtain first positioning information, wherein at least a first part of movement path from the first position to the second position is a path on which the automatic pool cleaning device moves along an edge of the pool;
control the automatic pool cleaning device to move from the second position to a third position on the bottom surface and perform a cleaning operation on the bottom surface;
control the automatic pool cleaning device to move from the third position to a fourth position on the bottom surface and do positioning at the fourth position to obtain second positioning information, wherein at least a second part of movement path from the third position to the fourth position is a path on which the automatic pool cleaning device moves along the edge of the pool; and
control the automatic pool cleaning device to move from the fourth position to the first position based on the first positioning information and the second positioning information.

13. A non-volatile computer-readable storage medium for storing computer program instructions, wherein the computer program instructions, when executed by a processor, implement the method according to claim 1.
